(19) United States
(12) Patent Application Publication
(10) Pub. No.: US 2018/0052412 A1
(43) Pub. Date: Feb. 22, 2018

(54) IMAGE FORMING APPARATUS

(71) Applicant: Funai Electric Co., Ltd., Osaka (JP)

(72) Inventors: Manabu Uchiyama, Osaka (JP); Yuki Miyazaki, Osaka (JP); Masanori Yamada, Nara-shi (JP); Akira Hayashi, Kakogawa-shi (JP); Shoichi Fukuyama, Osaka (JP)

(73) Assignee: Funai Electric Co., Ltd., Osaka (JP)

(21) Appl. No.: 15/647,376

(22) Filed: Jul. 12, 2017

(30) Foreign Application Priority Data
Aug. 18, 2016 (JP) 2016-160495

(51) Int. Cl. G03G 15/00

(52) U.S. Cl. CPC G03G 15/5029

(57) ABSTRACT

An image forming apparatus includes a housing; a mounting portion in the housing configured to hold a recording medium; one or more light receivers in the housing; a light adjuster that adjusts an amount of light incident on the light receivers based on presence or size of the recording medium on the mounting portion; and a controller that determines a size of the recording medium based on the amount of light that has been adjusted by the light adjuster.

### BACKGROUND OF THE INVENTION

### Technical Field

The present invention relates to an image forming apparatus, and more specifically relates to an image forming apparatus such as a printer that can determine various sizes of a recording medium such as paper.

### Related Art

Conventionally, image forming apparatuses such as those in patent documents 1 and 2, for example, are known as an image forming apparatus equipped with a size determining mechanism that can determine various sizes of a recording medium mounted on a mounting portion.

In patent document 1, an automatic document feeding device for an image forming apparatus equipped with a document detection sensor is disclosed. The document detection sensor is a reflective type optical sensor having a light emitter and a light receiving part, and the document detection sensor is configured so as to detect the document via a detection hole from below or inside a document feeding table.

Furthermore, in patent document 2, an image forming apparatus having a paper size detection device is disclosed. The paper size detection device is equipped with a guide member that can freely move for regulating an end portion of the paper contained in the paper cassette; a reflective member provided in the guide member, having a plurality of reflective surfaces in which the reflectance differs along the moving direction of the guide member; and a light receiving and emitting element for emitting light to the reflective surfaces of the reflective member, receiving the reflected light from the reflective surfaces, and outputting a detection signal corresponding to the amount of light received from the reflective surfaces. Furthermore, in patent document 2, a form of a transmitting member having a plurality of transmitting surfaces with different transmittances is also disclosed instead of a form of a reflective member having a plurality of reflective surfaces.

### [Patent Document]

[Patent Document 1] Japanese Unexamined Application Publication No. 2011-254216

[Patent Document 2] Japanese Unexamined Application Publication No. 2001-322723

### SUMMARY

In the document detection sensor of patent document 1, the sensor light emitted from the light emitter is reflected on the lower surface of the paper placed on the document feeding table via the detection holes, reaches the light receiving part, and is received by the light receiving part. However, for example, when the number of papers placed on the document feeding table is small, the sensor light emitted from the light emitter is transmitted through the paper, and the light receiving part may not be able to properly receive the sensor light. Alternatively, external light such as indoor illumination and the like may be transmitted through the paper, and the light receiving part may receive external light other than the sensor light. That is, in the document detection sensor of patent document 1, erroneous detection occurs easily, and in some cases, detection of paper size may not be reliably and appropriately carried out.

Furthermore, in the paper size detection device of patent document 2, a plurality of reflective surfaces having differing reflectance or a plurality of transmitting surfaces having differing transmittances corresponding to various types of paper sizes contained in the paper cassette are required. Thus, the detection device and the control mechanism thereof may become complicated, which increases the manufacture cost.

With the foregoing in mind, one or more embodiments of the invention may reliably and appropriately determine various sizes of a recording medium using a simple configuration.

The image forming apparatus according to one embodiment of the present invention is equipped with a housing; a mounting portion for mounting a recording medium, provided in the housing; at least one light receiving part provided in the housing; a change portion for changing the amount of light incident on the light receiving part based on the recording medium on the mounting portion, provided between the light receiving part and a light source for outputting light incident on the light receiving part; and a size determining part for determining size of the recording medium mounted in the housing, based on the amount of light received by the light receiving part that is changed by the change portion.

According to one or more embodiments of the present invention, because it is possible to change the amount of light incident on the light receiving part based on the recording medium on the mounting portion using the changing portion, it is possible to reliably and appropriately determine various sizes of a recording medium using a simple configuration.

### BRIEF DESCRIPTION OF THE DRAWINGS

FIG. 1 is an overall perspective view illustrating the internal structure of a printer as viewed from above according to one or more embodiments of the present invention.

FIG. 2 is a partially enlarged perspective view illustrating the structure of the mounting portion according to one or more embodiments of the present invention, as viewed from above.

FIG. 3 is a perspective view illustrating the configuration of a substrate and a light emitter according to one or more embodiments of the present invention.

FIG. 4 is a cross-sectional view of the IV-IV line shown in FIG. 1.

FIG. 5 is a schematic view illustrating the positional relationship between the range wherein light can be received by the light receiving part (circular region T) and the through hole according to one or more embodiments of the present invention.

FIG. 6 is a block diagram illustrating a configuration of a printer according to one or more embodiments of the present invention.

FIG. 7 is a view corresponding to FIG. 4 illustrating a variation of the printer according to one or more embodiments of the present invention.

FIG. 8 is an overall perspective view illustrating the internal structure of a printer as viewed from above according to one or more embodiments of the present invention.

FIG. 9 is a perspective view illustrating a configuration of the substrate, the light emitter, and the light receiver according to one or more embodiments of the present invention.

FIG. 10 is a partially enlarged perspective view illustrating the movement of the medium guide according to one or more embodiments of the present invention, as viewed from above.

FIG. 11 is a cross-sectional view of the XI-XI line shown in FIG. 8.

FIG. 12 is a view corresponding to FIG. 11 illustrating a state in which the medium guide overlaps the through hole according to one or more embodiments of the present invention.

FIG. 13 is a circuit diagram illustrating the connected state of the light emitter and the light receiver according to one or more embodiments of the present invention.

FIG. 14 is a block diagram illustrating a configuration of a printer according to one or more embodiments of the present invention.

FIG. 15 is a view corresponding to FIG. 11 illustrating a variation of the printer according to one or more embodiments of the present invention.

FIG. 16 is an overall perspective view of the internal structure of a printer as viewed from above according to one or more embodiments of the present invention.

FIG. 17 is a partially enlarged perspective view illustrating the structure of the mounting portion according to one or more embodiments of the present invention, as viewed from above.

FIG. 18 is a schematic diagram illustrating the relationship between the light emitter and the light receiver, and the light refractor according to one or more embodiments of the present invention.

FIG. 19 is a block diagram illustrating a configuration of a printer according to one or more embodiments of the present invention.

### DETAILED DESCRIPTION

Embodiments of the present invention will be described in detail below based on drawings. The following description of each embodiment is only an example, and is not intended to limit the present invention, its application, or its use. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### Example 1

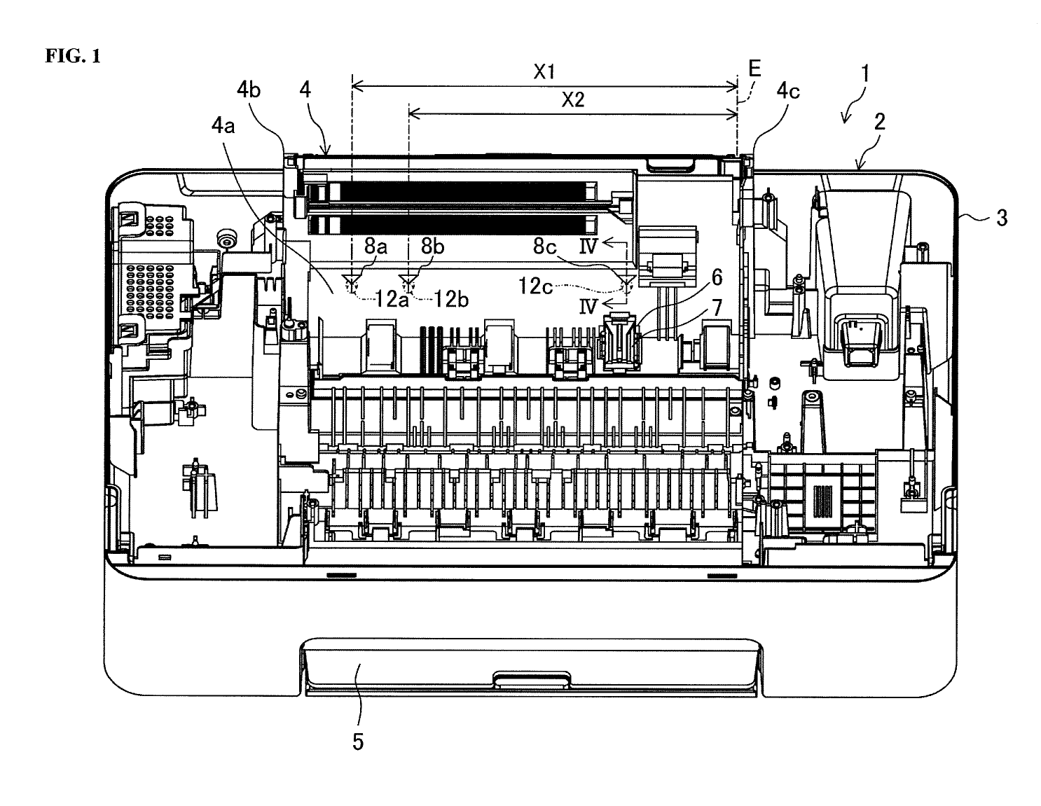

FIG. 1 illustrates a printer 1 according to one or more embodiments of the present invention. The printer 1 is an embodiment of the imaging formation device, and is applied, for example, as an inkjet printer. Note that in the printer 1 according to each embodiment described below, the position of a mounting portion 4 described later is set to the rear side of a housing 3 and the position of an ejection portion 5 is set to the front side (front surface side) of the housing 3. Then, the horizontal direction orthogonal to the front and rear direction is the left and right direction, and the vertical direction orthogonal to the front and rear direction as well as the left and right direction is the up and down direction.

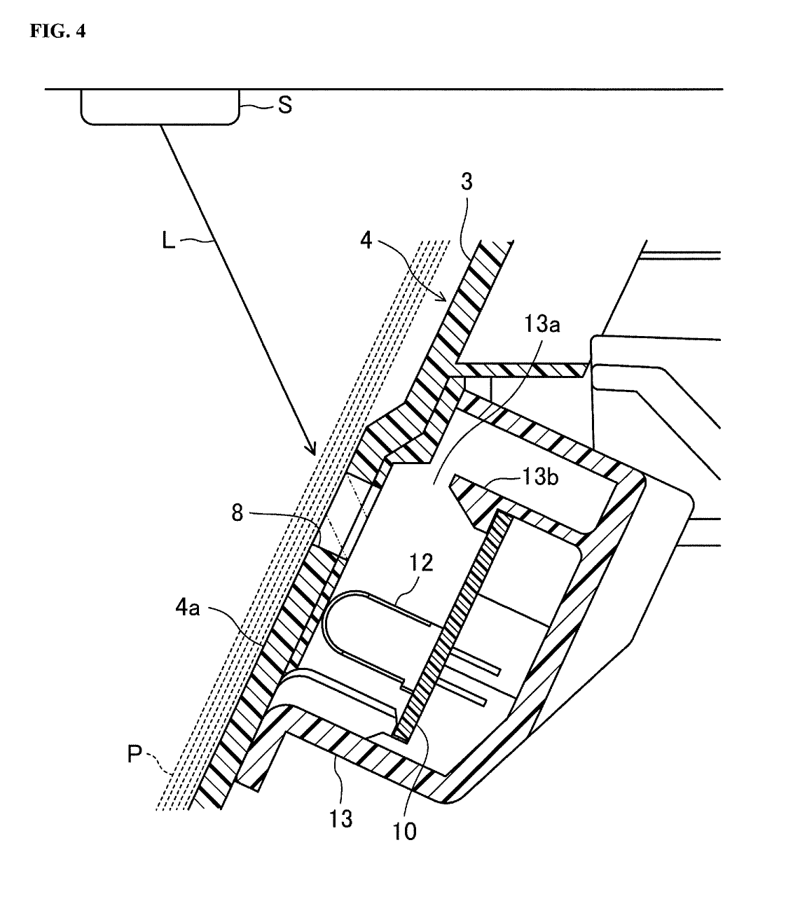

The printer 1 is equipped with a device body 2. The device body 2 has a resin housing 3, and a mounting portion 4 for mounting a paper as the recording medium is provided on the rear side of the housing 3 corresponding to various sizes. For example, the mounting portion 4 has a mounting surface 4a for mounting the paper of various sizes diagonally above. As illustrated in FIG. 1, the mounting surface 4a is formed in a range from a left side portion 4b to a right side portion 4c of the mounting portion 4. Furthermore, as illustrated in FIG. 4, the mounting surface 4a is inclined only at a predetermined angle (30° in the illustrated example) from the vertical direction so that the upper side faces the rear side of the housing 3. Then, the right side portion 4c of the mounting portion 4 is set as a reference position E (see FIG. 1), and each paper is mounted on the mounting surface 4a in a state where the side portions of each paper are aligned with the reference position E.

The ejection portion 5 is provided on the front side in the housing 3 to eject the paper fed from the mounting portion 4 into the housing 3. The paper mounted on the mounting surface 4a of the mounting portion 4 is sent to the ejection portion 5 along a transporting direction orthogonal to the width direction of the housing 3 using a feeding mechanism (not illustrated) provided in the housing 3.

Furthermore, the device body 2 is equipped with a cartridge 6 having a nozzle (not illustrated) for discharging ink, and a carriage 7 on which the cartridge 6 is mounted. The carriage 7 is configured to be able to reciprocate in the left and right direction in the housing 3. An image or the like is printed on a paper fed from the mounting portion 4 into the housing 3 by discharging ink from the nozzle of the cartridge 6 while reciprocating the carriage 7 in the left and right direction within the housing 3.

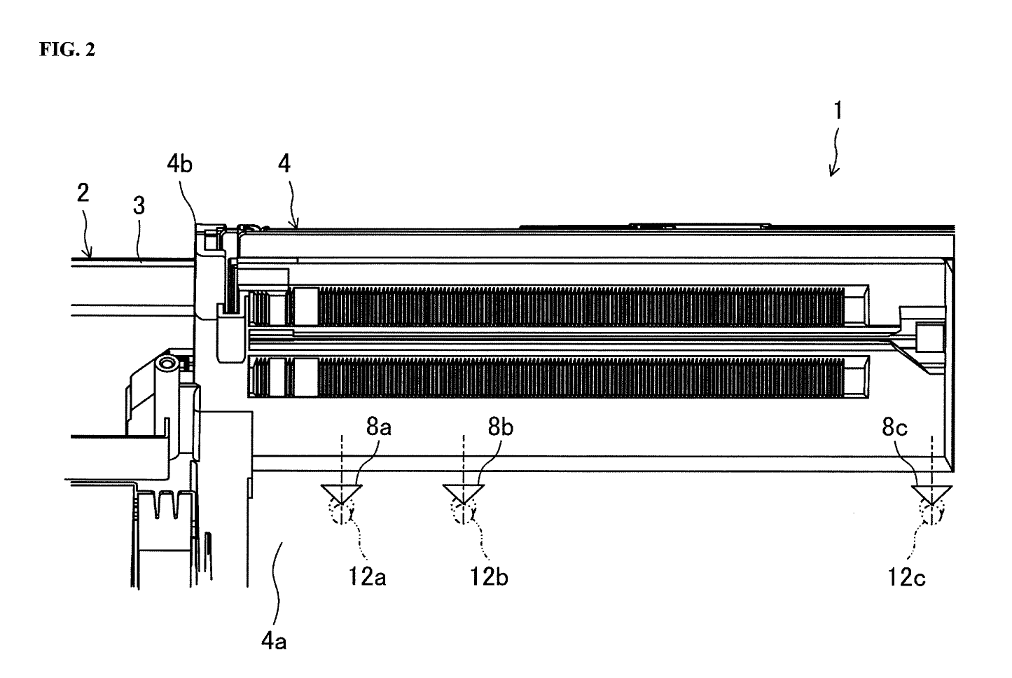

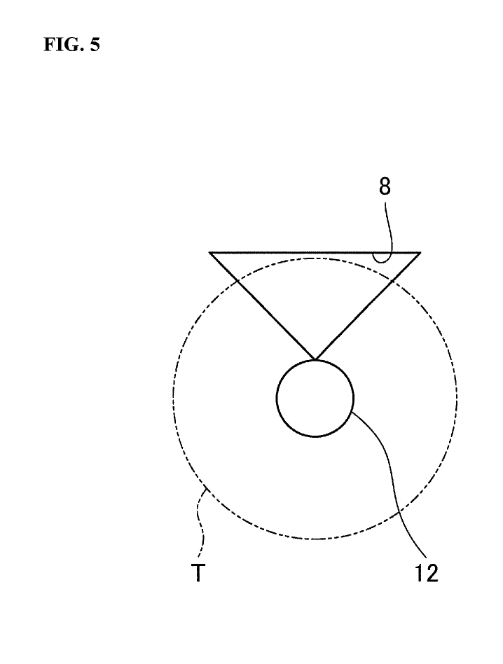

Next, as illustrated in FIG. 1, FIG. 2, and FIG. 4, a plurality (three in the illustrated example) of through holes 8 (8a, 8b, 8c) for passing through the mounting portion 4 are provided in the mounting portion 4. As illustrated in FIG. 5, the opening of each through hole 8 is formed in substantially a triangular shape so as to taper in the transporting direction. For example, the opening of each through hole 8 is formed in a right angle isosceles triangle in which the lower vertex angle is a right angle. Furthermore, as illustrated in FIG. 4, each through hole 8 is formed to pass through from the mounting surface 4a to each light receiving part 12 described later.

The through holes 8a, 8b, and 8c are disposed at intervals along the width direction of the housing 3 so as to correspond to each paper size mounted in the mounting portion 4. For example, as illustrated in FIG. 1, the through hole 8a formed near the left side portion 4b of the mounting portion 4 is disposed so that the center of the left and right width thereof is positioned at a position separated from the reference position E only by the dimension X1. Furthermore, the through hole 8b formed second from the left side is disposed so that the center of the left and right width thereof is positioned at a position separated from the reference position E only by a dimension X2. The through hole 8c formed near the right side portion 4c of the mounting portion 4 is provided to detect the presence and absence of a paper mounted in the mounting portion 4.

Here, the dimension X1 corresponds to a length (297 mm) in the longitudinal direction in an A4 sized paper horizontally placed on the mounting surface 4a of the mounting portion 4, or a length (279.4 mm) in the longitudinal direction in a letter size paper. Furthermore, the dimension X2 corresponds to a length (257 mm) in the longitudinal direction in a B5 size paper horizontally placed on the mounting surface 4a of the mounting portion 4.

Furthermore, as illustrated in FIG. 1, FIG. 2, and FIG. 4, a plurality (three in the illustrated example) of a light receiving part 12 (12a, 12b, and 12c) is disposed in a position corresponding to the position of each through hole 8. Each light receiving part 12 is stored in a storage space 13a in a storage space 13 described later. Furthermore, each light receiving part 12 is composed of, for example, a phototransistor for visible light. The light incident on the phototransistor is converted into a voltage in the phototransistor. The voltage is input in an AD converter (not illustrated) via an integrated circuit (not illustrated) in the device body 2, and is converted to a digital value using the AD converter. Then, the digital value is output to a size determining part 14 described later.

Here, as illustrated in FIG. 4, in the printer 1 according to the present embodiment, an illumination light or the like installed on the outside of the housing 3 (for example, indoors) is used as the light source S, and the light output from the illumination light becomes the light L incident on each light receiving part 12.

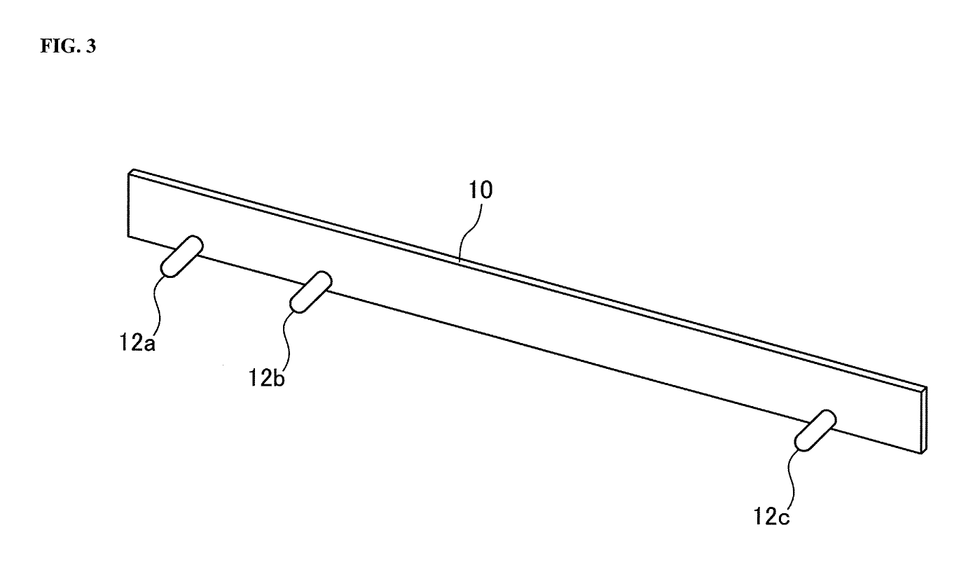

As illustrated in FIG. 3, each light receiving part 12 is provided on a rectangular substrate 10. For example, the plurality of light receiving part 12a, 12b, and 12c are placed at predetermined intervals along the longitudinal direction of the substrate 10 in a state rising in a direction orthogonal to the substrate 10 surface.

As illustrated in FIG. 4, the storage space 13 having a predetermined storage space 13a is provided on the opposite side of the mounting surface 4a of the mounting portion 4. The storage space 13 and the storage space 13a is formed so as to extend in the width direction of the housing 3. A support portion 13b protruding into the storage space 13a is integrally formed in the storage space 13, and the substrate 10 is fixed to the support portion 13b.

As a characteristic of the printer 1 according to the present embodiment, each through hole 8 is disposed at a position shifted more upward than the position of each light receiving part 12 in the transporting direction of the paper P along the mounting surface 4a of the mounting portion 4. In other words, as illustrated in FIG. 2 and FIG. 4, each light receiving part 12 is stored in the storage space 13a of the storage space 13 in a state hidden behind the mounting portion 4 as viewed from the front surface side of the housing 3. Furthermore, as illustrated in FIG. 5, a circular region T indicated by a virtual line represents a standard region in which light can be received by the light receiving part 12, and each through hole 8 is disposed corresponding to each light receiving part 12 so that the opening is partially included in the circular region T.

Due to the positional relationship between the through holes 8 and the light receiving parts 12, in a state in which there is no paper P in the mounting portion 4, the light L output from the light source S passes through the through hole 8 and is incident on each light receiving part 12 so as to be along an inclined direction inclined upward by only a predetermined angle with respect to the protruding direction of the light receiving part 12 (see FIG. 4).

Furthermore, as described above, because the through hole 8 is disposed at a position shifted upward from the position of the light receiving part 12, as indicated by the virtual line in FIG. 4, the light L passes through a region more narrow than the actual opening in the through hole 8 and incident in the light receiving part 12. That is, the incident angle of the light L when incident on the light receiving part 12 is limited by the positional relationship of the through hole 8 and the light receiving part 12, and the light L incident on the light receiving part 12 is narrowed. Thus, the light L slightly attenuates as it passes through the through hole 8. Then, the amount of light L is slightly smaller than the amount of light immediately after being output from the light source S to being incident on the light receiving part 12 from the through hole 8. However, because the opening of the through hole 8 as described above is partially included in the circular region T, even when the light receiving part 12 is hidden behind the mounting portion 4, the light L passing through the through hole 8 is directly incident on the light receiving part 12.

Meanwhile, as illustrated in FIG. 4, in a state in which there is a paper P on the mounting portion 4, the light L passes through the paper P so as to be inclined with respect to the thickness direction, and the light L is significantly attenuated in the process. For example, due to the through hole 8 being disposed in a state shifted from the light receiving part 12, the light L incident on the light receiving part 12 is narrowed down in the through hole 8, and for example, compared to a state in which the position of the through hole 8 is aligned with the light receiving part 12, and the light L passes through in the vertical direction with respect to the paper P on the mounting surface 4a, it can be secured for a longer distance (attenuation distance) until the light L is incident on the light receiving part 12. Then, due to the paper P and the through hole 8 mounted on the mounting surface 4a the amount of light L incident on the light receiving part 12 significantly attenuates more than the light amount when output from the light source S. As a result, there is an amount of light L smaller than when no paper P is on the mounting portion 4 is incident on light receiving part 12 in a position in which the though hole 8 is blocked by the paper P.

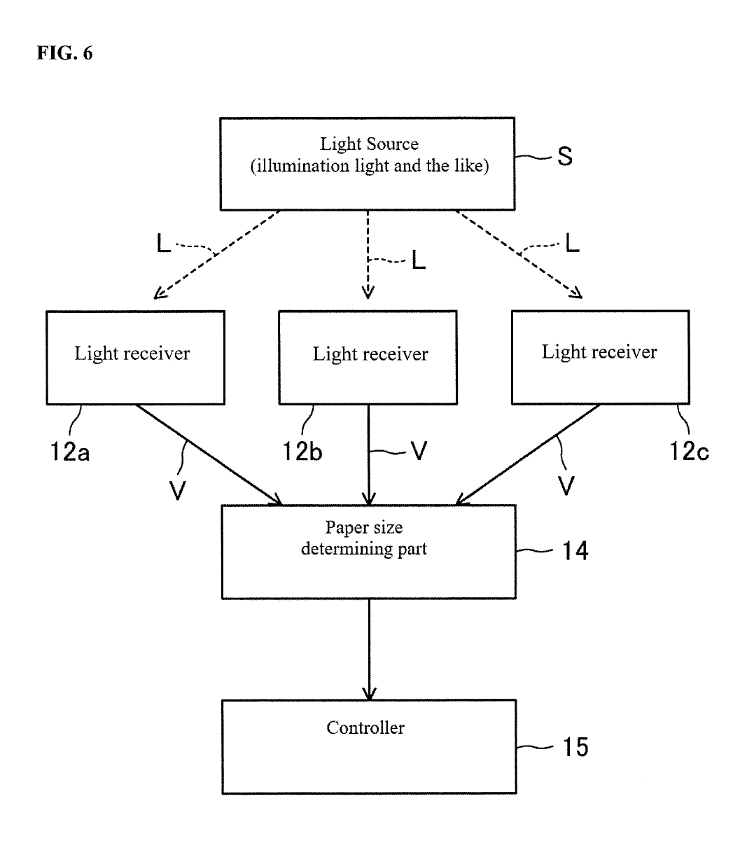

Then, as illustrated in FIG. 6, the printer 1 has a size determining part 14 for determining the size of each paper mounted on the mounting portion 4 based on the amount of light incident on the light receiving part 12, and the number and position of light receiving part 12 on which the light L is incident. For example, the aspect for determining various sizes of paper are as follows.

In the size determining part 14, when an output voltage (hereinafter “output voltage V1”) is detected corresponding to when the amount of light L attenuated from all of the light receiving part 12a, 12b, and 12c is incident, the size determining part 14 determines that an A4 size paper or a letter size paper is mounted on the mounting portion 4 in a horizontal state.

In the size determining part 14, when an output voltage (hereinafter “output voltage V2”) is detected corresponding to when the amount of light L not attenuated from only light receiving part 12a is incident (that is, the light L guided from the through hole 8a to the direct light receiving part 12a without passing through the paper P), and when the output voltage V1 from the other light receiving part 12b and 12c are detected, the size determining part 14 determines that a B5 size paper is mounted on the mounting portion 4 in a horizontal state.

In the size determining part 14, when the output voltage V2 from both light receiving part 12a and 12b is detected, and when the output voltage V1 from the light receiving part 12c is detected, the size determining part 14, for example, determines that a postcard size paper, paper less than or equal to B5 size, envelope, L size, and the like is mounted in the mounting portion 4.

In the size determining part 14, when the output voltage V2 is detected from all of the light receiving part 12a, 12b, and 12c, the size determining part 14 determines that no paper of any size is mounted on the mounting portion 4.

Then, as illustrated in FIG. 6, the size determining part 14 sends each determination result to a controller 15 composed of a CPU provided in the device body 2. The controller 15 operates each mechanism such as the carriage 7 and the like based on the determination results. In one or more embodiments of the invention, the paper size determining part 14 may be implemented in software that is performed by the controller 15 or the CPU thereof.

### (Operation Effect of Example 1)

As described above, the through hole 8 is configured so that the path of the light L incident on the light receiving part 12 is narrowed in advance. Then, as described above, in a state in which there is paper P on the mounting portion 4, the amount of light L output from the light source S is significantly attenuated by the paper P and the though hole 8, and the amount of light L smaller than the state in which no paper P is on the mounting portion 4 is incident on the light receiving part 12. As a result, it is possible to reliably distinguish the amount of light L incident on the light receiving part 12 based on the paper P mounted on the mounting portion 4. That is, the through hole 8 is provided between the light receiving part 12 and the light source S, and functions as a change portion (light guiding portion) for changing the amount of light L when the light L from the light source S is incident on the light receiving part 12 based on the presence and absence of paper P on the mounting portion 4.

Therefore, in the printer 1 according to this embodiment, it is possible to change the amount of light when the light L from the light source S is incident on the light receiving part 12 based on the paper P on the mounting portion 4, and reliably and appropriately determine the paper size so that erroneous detection does not occur.

Furthermore, in the printer 1 according to this embodiment, by providing a through hole 8 passing through from the mounting surface 4a to the mounting portion 4 to the light receiving part 12, the mechanism for detecting the paper size equipped with a change portion (light guiding portion) can be simplified, and the cost of the device body in the printer 1 can be reduced.

Furthermore, because the storage space 13 having a storage space 13a for storing the light receiving part 12 is provided on the opposite side of the mounting surface 4a in the mounting portion 4, the light L guided from the through hole 8 can be effectively caused to be incident on the light receiving part 12.

Furthermore, because the opening in each through hole 8 is formed in substantially a triangular shape so as to taper toward the transporting direction, when setting the paper P on the mounting portion 4 (mounting surface 4a) along the transporting direction, the lower end portion of the paper P does not catch on each through hole 8, and the paper P can be smoothly mounted on the mounting portion 4 (mounting surface 4a).

Furthermore, in the printer 1 according to this embodiment, because an illumination light and the like on the outside of the housing 3 is used as the light source S, it is unnecessary to additionally provide a dedicated light emitter composed of an LED as the light source S, and the mechanism for detecting the paper size can be simplified, thus reducing the cost of the device body in the printer 1.

### (Variation of Example 1)

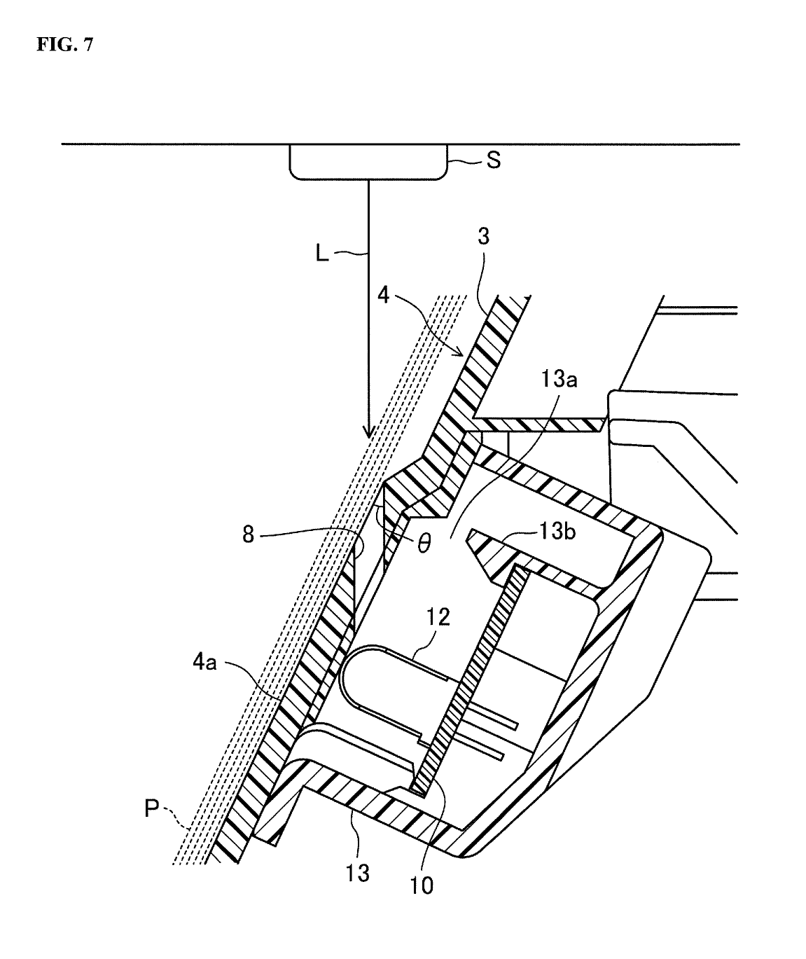

FIG. 7 illustrates a variation of example 1.Note that in the following variation and the description of the embodiments, the same portions in FIG. 1 through 6 will be denoted by the same reference numerals, and a detailed description thereof will be omitted.

As illustrated in FIG. 7, each through hole 8 is formed at an incline with respect to the mounting surface 4a so as to pass through from the mounting surface 4a on the mounting portion 4 to each light receiving part 12. By providing the through hole 8 as such, the light L passing through along the hole direction of the through hole 8 can be caused to be more efficiently incident on each light receiving part 12.

In particular, the through hole 8 in the variation is configured to incline only at a predetermined angle θ (θ=30° in the illustrated example) with respect to the mounting surface 4a. Thus, for example, compared to the through hole 8 in which the angle θ is formed to be 90° (that is, a state formed to pass through in the vertical direction with respect to the mounting surface 4a), the distance from the paper P to each light receiving part 12 is approximately doubled, and the attenuation distance of the light L can be secured to a longer distance. As a result, the amount of light L incident on the light receiving part 12 can more reliably be distinguished based on the presence and absence of paper P mounted on the mounting portion 4. Note that the angle θ in this variation is set to 30°, but it is not limited to this angle, and may be set to an angle less than 90°.

(Another example relating to example 1)

In the printer 1 according to this embodiment, an aspect using the through hole 8 as the change portion (light guiding portion) is illustrated, but it is not limited to this. For example, it may be a light guiding portion in which each through hole 8 is blocked by a transparent member such as a transparent glass member, acrylic member, and the like. In this case, the opening of each through hole 8 is not limited to the substantially triangular shape as described above, and may be formed in a polygonal shape including a square shape, or a circular shape. That is, the change portion (light guiding portion) is provided between the light receiving part 12 and the light source S, and may function for changing the amount of light when the light L from the light source S is incident on the light receiving part 12 based on the presence and absence of paper P on the mounting portion 4.

### Example 2

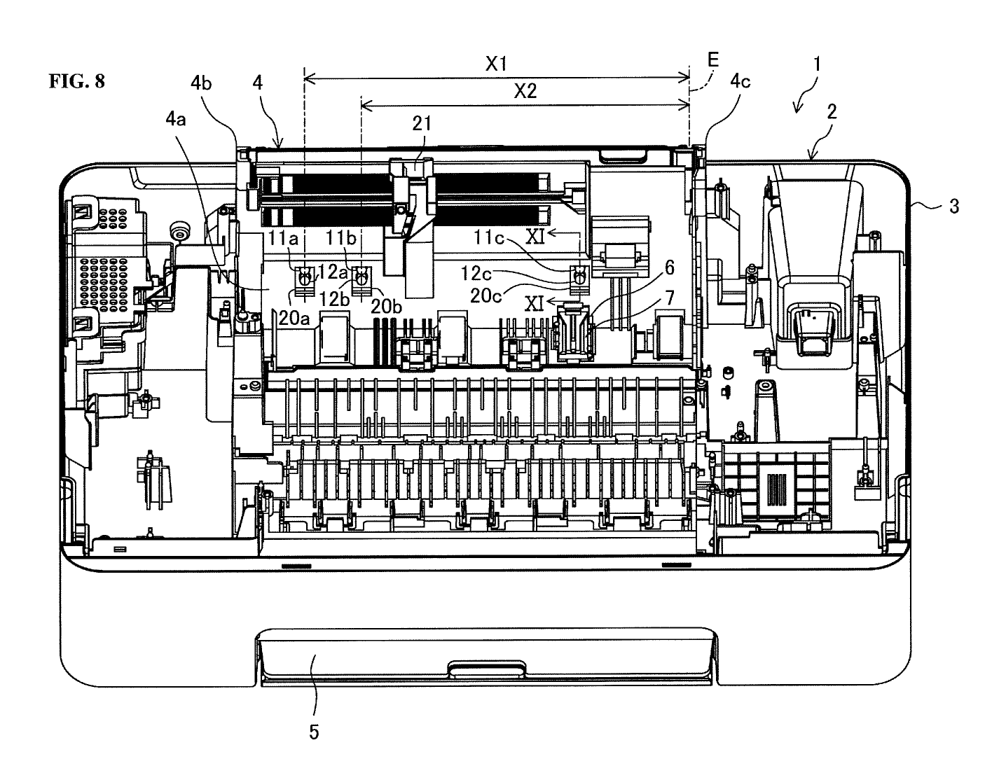

FIG. 8 through 14 illustrate the printer 1 according to one or more embodiments of the present invention. In this embodiment, compared to example 1, the specific configuration differs in the light source, the through hole, and the change portion. Note that in the following description, the same portions in FIG. 1 through 7 will be denoted by the same reference numerals, and a detailed description thereof will be omitted.

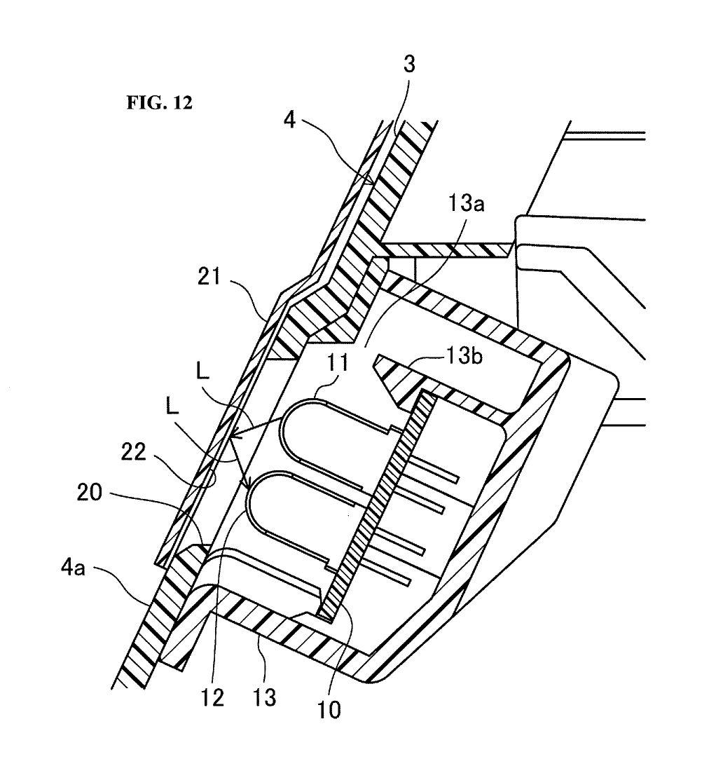

In this embodiment, as illustrated in FIG. 8 and FIG. 12, a plurality (three in the illustrated example) of through holes 20 (20a, 20b, 20c) formed passing through in a substantially rectangular shape are provided in the mounting portion 4. The through holes 20a, 20b, and 20c, similar to example 1, are disposed at intervals along the width direction of the housing 3 in positions to correspond to each paper P size mounted in the mounting portion 4.

As illustrated in FIG. 8 through 12, in the printer 1 according to this embodiment, a plurality (three in the illustrated example) of light receiving part 12 (12a, 12b, 12c) composed of a phototransistor are provided in the housing 3. Furthermore, a plurality (three in the illustrated example) of light emitters 11 (11a, 11b, 11c) composed of an LED element are provided as the light source in the housing 3, and the light output from the end portion of each light emitter 11 is the light L incident on the end portion of each light receiving part 12.

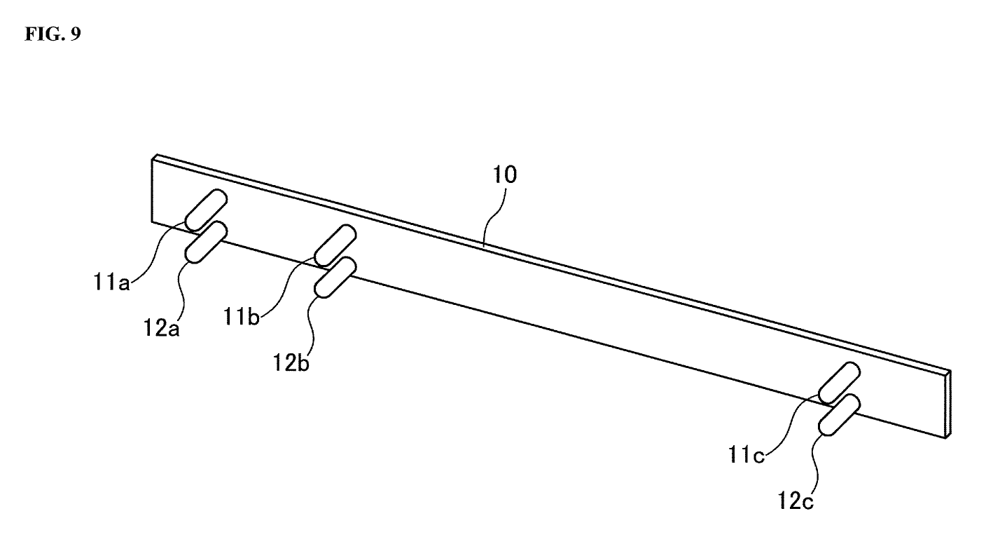

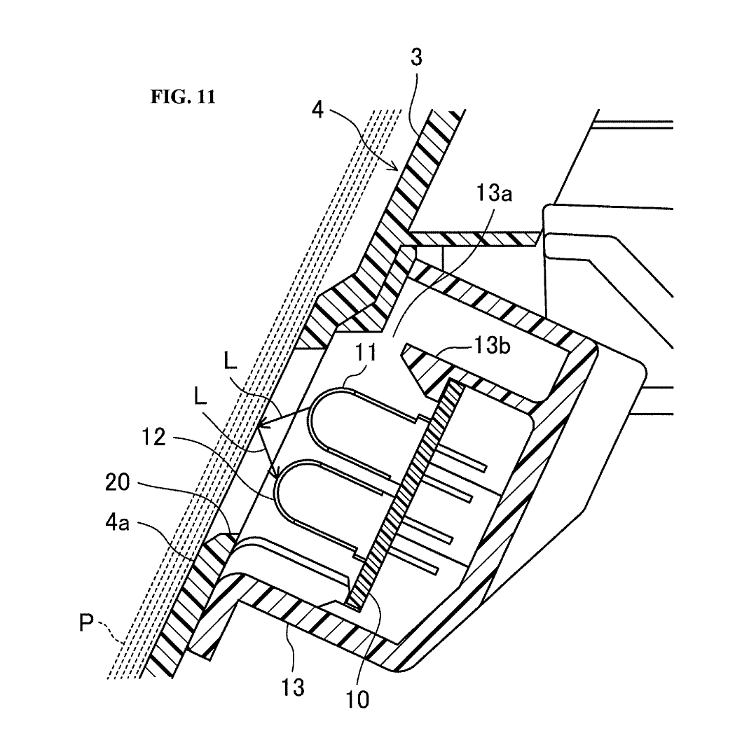

For example, each light emitter 11 and each light receiving part 12 are disposed close to each other so as to form a pair on positions corresponding to the position of each through hole 20 on the opposite side (back side) of the mounting surface 4a on the mounting portion 4. As illustrated in FIG. 9, each light emitter 11 and each light receiving part 12 are placed at a predetermined interval on the substrate 10 along the longitudinal direction of the substrate 10 in a state raising in a vertical direction with respect to the back side of the substrate 10 and, for example, forming a pair vertically. Note that in this embodiment, the light emitters 11a, 11b, and 11c are disposed on the upper side, and furthermore, the light receiving part 12a, 12b, and 12c are respectively disposed on the lower side. As also illustrated in FIG. 11 and FIG. 12, each light emitter 11 and each light receiving part 12 are stored in the storage space 13a in a state in which the substrate 10 is fixed to the supporting portion 13b of the storage space 13.

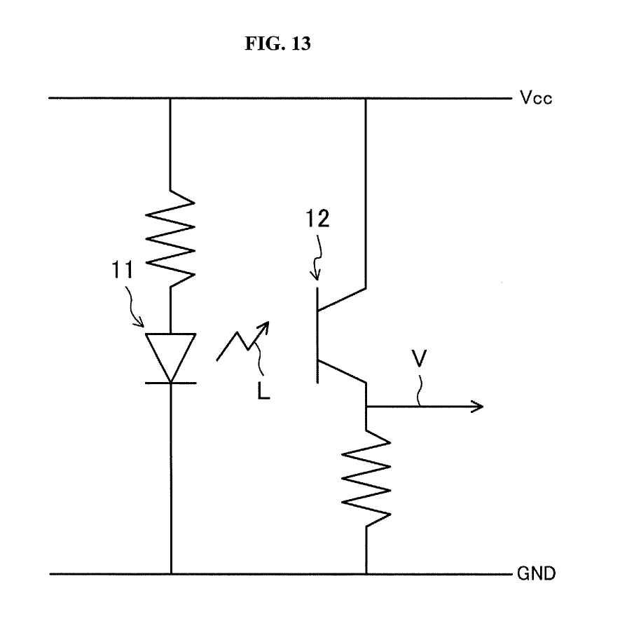

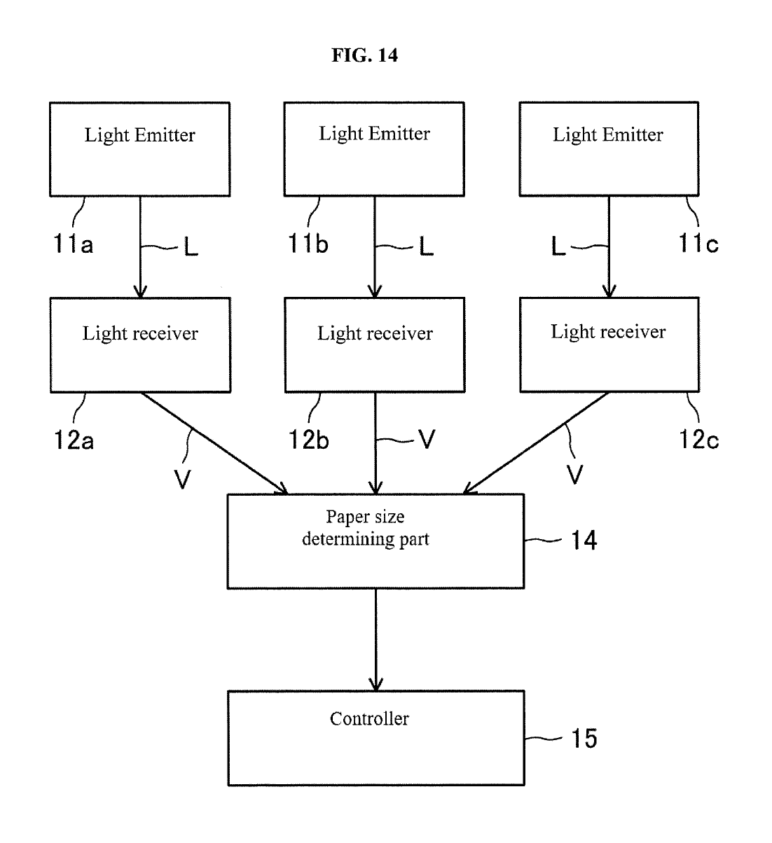

As illustrated in FIG. 13, each light receiving part 12 is in a state of always being able to receive the light L output from the each light emitter 11, and when the light L is reflected, the reflected light L is incident on each adjacent light receiving part 12. As illustrated in FIG. 14, each light receiving part 12, similar to example 1, is configured so as to output a voltage corresponding to the amount of incident light L to the size determining part 14.

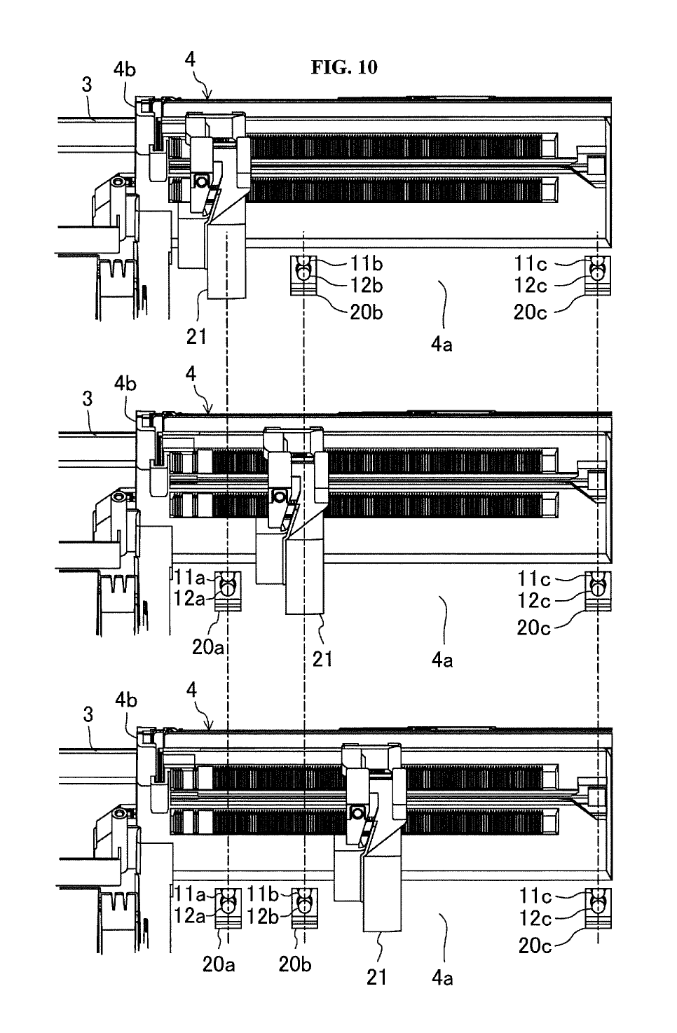

As a characteristic of the printer 1 according to this embodiment, as illustrated in FIG. 8, the printer 1 is equipped with a medium guide 21 that can move along the width direction of the mounting portion 4. As illustrated in FIG. 10, the medium guide 21 stops at a position overlapping any one of the through holes 20a, 20b, and 20c, and is configured to limit the position of each paper P by holding the end portion of each paper P mounted on the mounting surface 4a on the mounting portion 4 in the stopped position.

Furthermore, as illustrated in FIG. 12, the reflective surface 22 is formed in the medium guide 21 on the side opposite the mounting surface 4a on the mounting portion 4. The reflective surface 22 is treated, for example, as a mirror surface so as to increase the reflectance of light. That is, the reflective surface 22 is configured so as to reflect the light L toward the light receiving part 12 at a portion within the through hole 20 when the through hole 20 is blocked by overlapping any one of the through holes 20a, 20b, and 20c by the movement of the medium guide 21.

The size determining part 14 according to this embodiment is configured so as to determine the size of each paper P mounted on the mounting portion 4 based on the amount of light L to the light receiving part 12 reflected by the reflective surface 22 on the medium guide 21. Furthermore, each light receiving part 12 is set so that the medium guide 21 does not overlap the through hole 20, the output voltage is not the maximum value when the light L reflected by the paper P is incident, and the output voltage is the maximum value when the light L reflected by the reflective surface 22 of the medium guide 21 is incident due to the medium guide 21 overlapping the through hole 20. The aspect for determining the specific size of each paper will be described below.

The size determining part 14 determines that an A4 size or letter size paper P is mounted on the mounting portion 4 when the size determining part 14 detects an output voltage of the maximum value from only the light receiving part 12a and an output voltage less than the maximum value from the other light receiving part 12b and 12c. In this case, as illustrated in FIG. 10, the medium guide 21 overlaps the through hole 20a.

The size determining part 14 determines that a B5 size paper P is mounted on the mounting portion 4 when the size determining part 14 detects an output voltage of the maximum value from only the light receiving part 12b and detects an output voltage less than the maximum value from only the light receiving part 12c. In this case, as illustrated in FIG. 10, the medium guide 21 overlaps the through hole 20b.

The size determining part 14 determines that a postcard size paper P is mounted on the mounting portion 4 when the size determining part 14 detects an output voltage less than the maximum value from only the light receiving part 12c, and does not detect an output voltage from the other light receiving part 12a and 12b. In this case, as illustrated in FIG. 10, the medium guide 21 is positioned between the through hole 20b and the through hole 20c.

Note that the size determining part 14 determines that no paper P of any size is mounted on the mounting portion 4 when an output voltage is not detected from the light receiving part 12c.

Then, as illustrated in FIG. 14, the size determining part 14 sends each determination result to the controller 15. The controller 15 operates each mechanism such as the carriage 7 and the like based on the determination results.

The other configurations of the printer 1 in example 2 are similar to the configurations of the printer 1 according to example 1.

### (Operation Effect of Example 2)

As described above, the medium guide 21 (reflective surface 22) in this embodiment is interposed between the light receiving part 12 and the light emitter 11, and functions as the change portion for changing the amount of light L based on the paper P on the mounting portion 4 when the light L from the light emitter 11 is incident on the light receiving potion 12. Then, in the printer 1 according to this embodiment, the position of each paper P mounted on the mounting surface 4a on the mounting portion 4 can easily be aligned using the medium guide 21, and the amount of light can be changed when the light L from each light emitter 11 is incident on the light receiving part 12 based on the paper P on the mounting portion 4 by using the medium guide 21 (reflective surface 22) correlating to the change portion. Therefore, in the printer 1 according to this embodiment, the paper size can also be reliably and appropriately determined.

Furthermore, the light receiving part 12 is set so that the output voltage is the maximum voltage when the light L reflected by the reflective surface 22 on the medium guide 21 is incident by the medium guide 21 overlapping the through hole 20. Therefore, the difference between the output voltage having the maximum value and the output voltage from the light receiving part 12 when the light L reflected on the rear surface of the paper P in the through hole 20 is incident by the medium guide 21 not overlapping the through hole 20 appears large. Due to this voltage difference, both output voltages can be reliably distinguished, and erroneous detection of the paper size by the size determining part 14 can be prevented in advance.

### (Variation of Example 2)

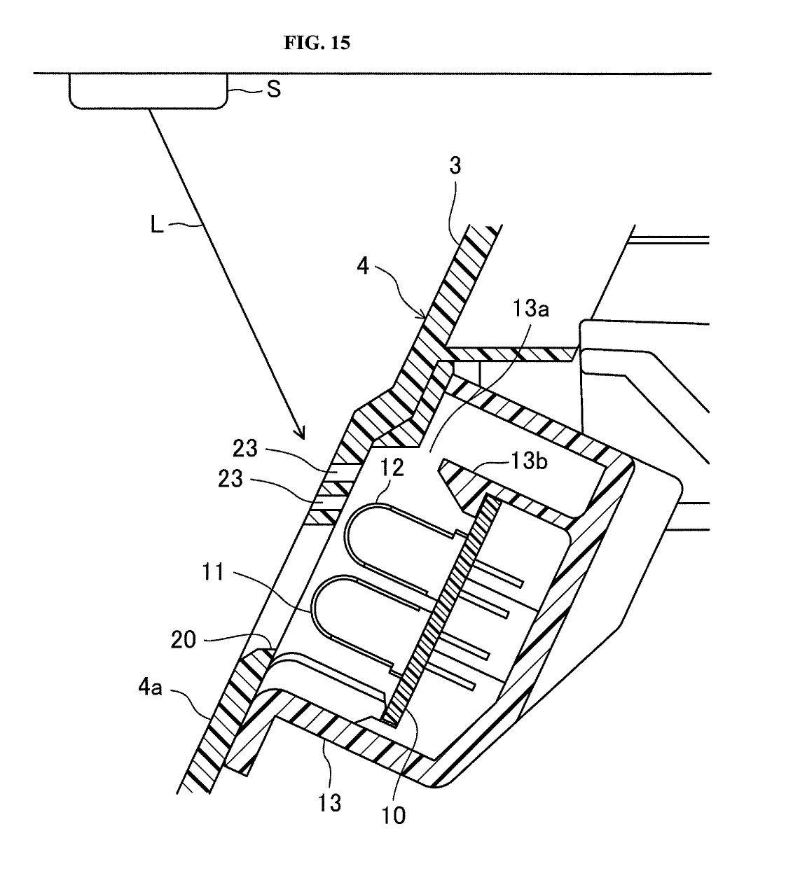

FIG. 15 illustrates a variation of the example 2. Note that in the following description, the same portions in FIG. 7 through 14 will be denoted by the same reference numerals, and a detailed description thereof will be omitted.

In this variation, as illustrated in FIG. 15, for each light emitter 11 and each light receiving part 12, each light receiving part 12 is disposed on the upper side while each light emitter 11 is disposed on the lower side. Furthermore, a plurality of slits 23 are provided in the mounting portion 4. For example, the slits 23 are formed to pass through a horizontally elongated hole at the position of each through hole 20 opposing each light receiving part 12 and disposed at intervals in the vertical direction. The other configurations of the printer 1 according to this variation are similar to the configuration of the printer 1 according to example 2.

By providing such slits 23, it is possible to shield the light from outside the housing 3 (for example, light output from an interior illumination light) in front of each light receiving part 12 so to not be incident on each light receiving part 12. As a result, when there is no paper on the mounting surface 4a on the mounting portion 4, light from the outside of the housing 3 being incident on the light receiving part 12 is prevented, and it is possible to reliably determine that there is no paper on the mounting surface 4a of the mounting portion 4 by the size determining part 14.

### Example 3

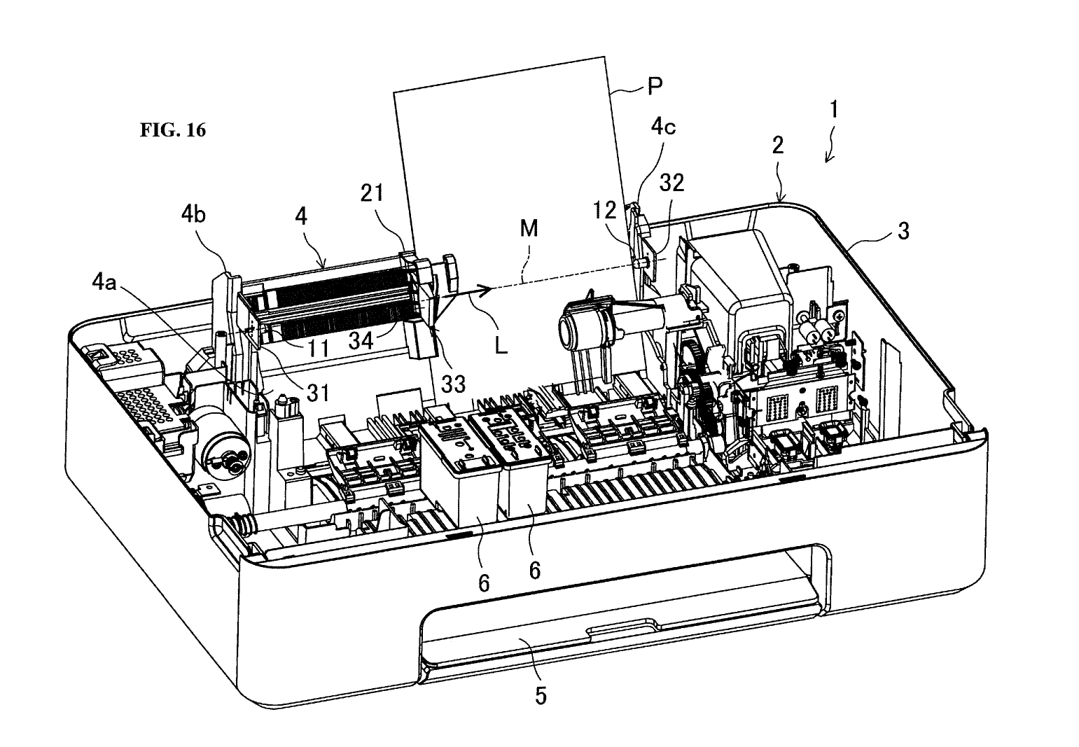

FIG. 16 through 19 illustrate the printer 1 according to one or more embodiments of the present invention. In this embodiment, the specific configuration of the light emitter, light receiving part, and change portion differs compared to example 2. Furthermore, in the printer 1 according to one or more embodiments of the present invention, through holes 20 as in example 2 are not provided. Note that in the following description, the same portions in FIG. 8 through 14 will be denoted by the same reference numerals, and a detailed description thereof will be omitted.

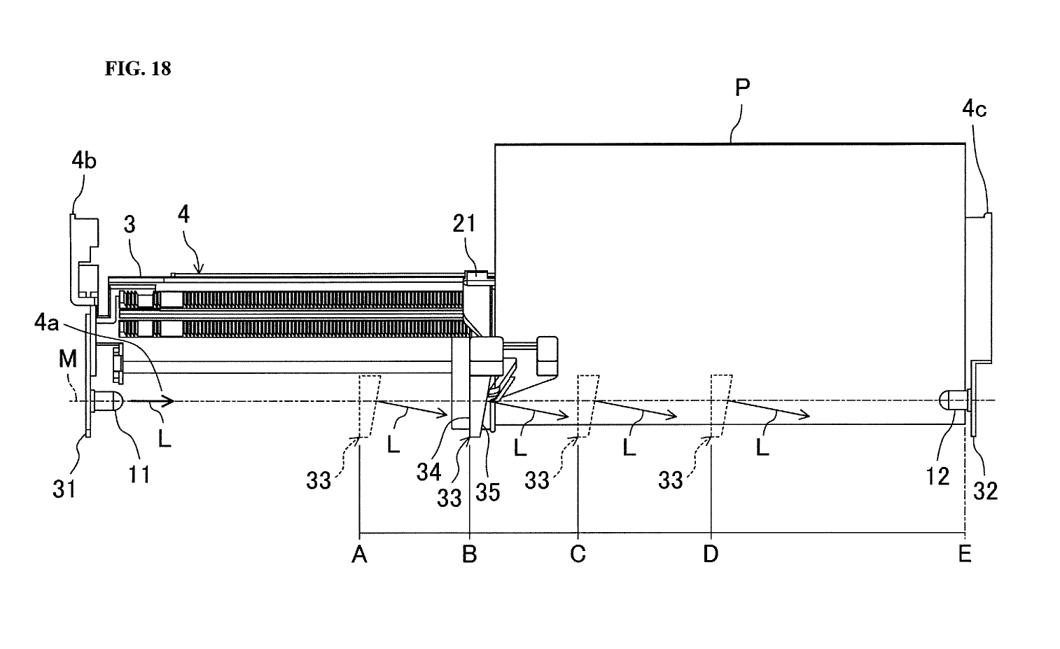

In the printer 1 according to this embodiment, one light emitter 11 composed of an LED element provided in the housing 3 is used as the light source. As illustrated in FIG. 16 through 18, the light emitter 11 is provided at one end portion in the width direction of the mounting portion 4. For example, a substantially plate-shaped first attachment plate 31 extending in the front and back direction is fixed to, for example, a left side portion 4b on the mounting portion 4, and the light emitter 11 is attached to, for example, a right side surface of the first attachment plate 31 so as to output the light L (see FIG. 18) towards the right direction (inner side in the width direction of the housing 3).

Furthermore, the light receiving part 12 is provided in the light emitter 11 opposing the left and right direction on the other end portion in the width direction of the mounting portion 4. For example, a substantially plate-shaped second attachment plate 32 extending in the front and back direction is fixed to a right side portion 4c on the mounting portion 4, and the light receiving part 12 is attached to, for example, a left side surface of the second attachment plate 32 so as to face the left and right direction, that is, towards the light emitter 11 side. The light receiving part 12 is composed of a phototransistor, similar to example 2. Then, the light emitter 11 and the light receiving part 12 are disposed so as to be positioned on the same straight line M in a position at the same height, and the light L output from the light emitter 11 is incident on the light receiving part 12.

As illustrated in FIG. 16 to FIG. 18, the printer 1 is equipped with a medium guide 21 that can move along the width direction of the mounting portion 4 (direction of straight line M). The medium guide 21, similar to example 2,is configured so as regulate the position of each paper P with respect to the mounting portion 4 by holding the inner portion of each paper P mounted on the mounting surface 4a on the mounting portion 4. Note that the medium guide 21 in this example, differing from example 2, does not have a reflective surface 22 formed.

Furthermore, as a characteristic of the printer 1 according to this embodiment, a substantially plate-shaped light refractor 33 positioned on the straight line M connecting the light emitter 11 and the light receiving part 12 is fixed in the front end portion of the medium guide 21. The light refractor 33 refracts the light L output from the light emitter 11 and incident on the light receiving part 12 in the middle, and is formed in a substantially rectangular shape as viewed from the side surface, composed of, for example, a transparent glass material or acrylic material.

In addition, as illustrated in FIG. 18, the light refractor 33 has an incident surface 34 whereon the light L from the light emitter 11 is incident and is orthogonal to the incident direction of the light L (that is, the direction of straight line M), and an emission surface 35 inclined at only a predetermined angle (10° in the illustrated example) with respect to the incident surface 34 and for emitting light L incident on the incident surface 34 to the light receiving part 12. For example, the emission surface 35 is inclined so as to come closer to the incident surface 34 side (left side of the housing 3) facing the front side of the housing 3. Due to such an inclined emission surface 35, the light refractor 33 is configured so as to cause the light L output from the light emitter 11 towards the light receiving part 12 to be incident on the light receiving part 12 by refracting toward the front side of the housing 3 only at a predetermined angle with respect to the straight line M direction.

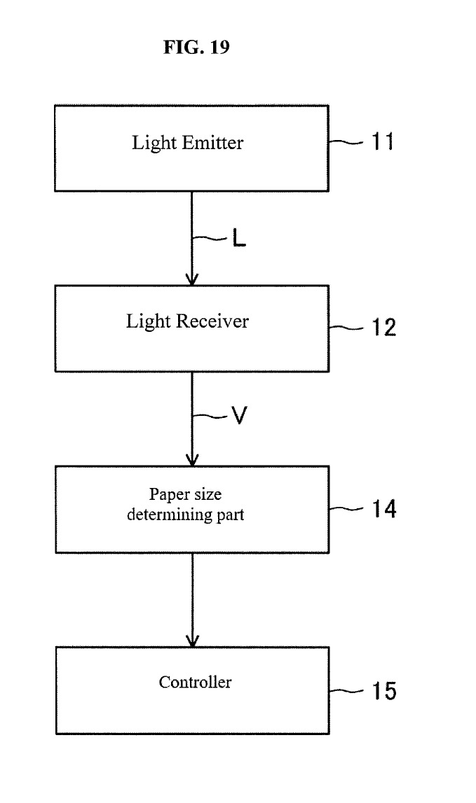

In the printer 1 according to this embodiment, the refractive position of the light L from the light refractor 33 on the straight line M is changed according to the position of the medium guide 21, and changes the amount of light L incident on the light receiving part 12. Then, the size determining part 14 (see FIG. 19) is configured to determine the size of each paper P mounted on the mounting portion 4 based on the change in amount of light L incident on the light receiving part 12 corresponding to the position of the medium guide 21. The aspect for determining the specific size of each paper P is as follows.

As illustrated in FIG. 18, when the position of the medium guide 21 is aligned with the maximum size paper P mounted on the mounting portion 4, the medium guide 21 is in a state separated from the light receiving part 12 as much as possible (the light reactive portion 33 is positioned at point A). In this state, the distance in the front and back direction between the light L refracted by the light refractor 33 and the light receiving part 12 is a maximum. Then, the amount of light L incident on the light receiving part 12 is a minimum, and the value of the voltage output from the light receiving part 12 is a minimum. Thus, when the size determining part 14 detects a minimum output voltage, the size determining part 14 determines that the maximum size (for example, letter size) paper P is mounted on the mounting portion 4.

Meanwhile, when the position of the medium guide 21 is aligned with the minimum size paper P mounted on the mounting portion 4, the medium guide 21 is in a state as close to the light receiving part 12 as possible (the light reactive portion 33 is positioned at point D). In this state, the distance in the front and back direction between the light L refracted by the light refractor 33 and the light receiving part 12 is a minimum. Then, the amount of light L incident on the light receiving part 12 is a maximum, and the value of the voltage output from the light receiving part 12 is maximum. Thus, when the size determining part 14 detects a minimum output voltage, the size determining part 14 determines that the minimum size (for example, postcard size) paper P is mounted on the mounting portion 4.

Furthermore, when the position of the medium guide 21 is aligned with vertically placed A4 sized paper P mounted on the mounting portion 4, and when the light refractor 33 is positioned at point B separated at only a predetermined distance from reference position E, the voltage value output from the light receiving part 12 becomes a predetermined voltage value due to the change in distance in front and back direction between the light L refracted by the light refractor 33 and the light receiving part 12. In addition, when the position of the medium guide 21 is aligned with the vertically placed B5 sized paper P mounted on the mounting portion 4, and when the light refractor 33 is positioned at point C separated only a predetermined distance from the reference point E, a voltage larger than in the case of the A4 size is output from the light receiving part 12. Thus, the size determining part 14 determines the size of each paper P mounted on the mounting portion 4 by the voltage value output from the light receiving part 12.

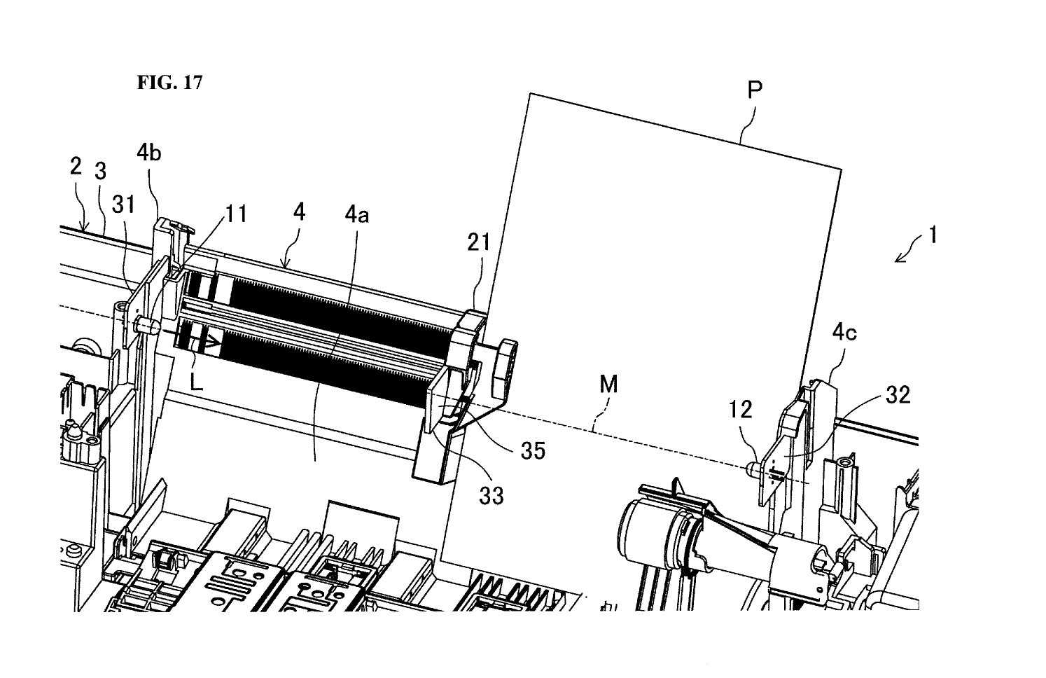

Note that in FIG. 17, a state is illustrated in which the position of the medium guide 21 is aligned with a vertically placed A4 sized paper P mounted on the mounting portion 4.

Then, as illustrated in FIG. 19, the size determining part 14 sends each determination result to the controller 15. The controller 15 operates each mechanism such as the carriage 7 and the like based on the determination results.

### (Operation Effect of Example 3)

As described above, the light refractor 33 is provided between the light emitter 11 and the light receiving part 12, and functions as a change portion that changes the amount of light based on the paper P on the mounting portion 4 when the light L from the light emitter 11 is incident on the light receiving part 12. Then, in the printer 1 according to this embodiment, it is possible to easily align the position of each paper P mounted on the mounting surface 4a on the mounting portion 4 using the medium guide 21. Along with that, due to the light refractor 33 (change portion) moving along with the medium guide 21, because the amount of light L incident on the light receiving part 12 changes based on the paper P on the mounting portion 4, the paper size can be reliably and easily determined. Furthermore, in the printer 1 according to this embodiment, because it may be configured to provide the one of the light emitters 11 and the light receiving part 12, the mechanism for detecting the paper size can be simplified, and cost of the entire device body in the printer 1 can be reduced.

Furthermore, in the light refractor 33, the light L output from the light emitter 11 is incident on the incident surface 34 and passes through the inside of the light refractor 33 along the direction of the straight line M. Meanwhile, the light L passing through the inside of the light refractor 33 is refracted toward the front side of the housing 3 by the emission surface 35 at only a predetermined angle with respect to the direction of the straight line M. In addition, the light refractor 33 is integrally provided with the medium guide 21, and is configured so as to move along the straight line M along with the medium guide 21. Therefore, due to the medium guide 21 being caused to move, while maintaining an angle of the incident surface 34 and the emission surface 35 with respect to the straight line M, it is possible for the light refractor 33 (incident surface 34 and emission surface 35) to move closer to or separate farther from the light receiving part 12. Meanwhile, when the light L is refracted by the emission surface 35 at a position where the light refracting portion 33 is separated far from the light receiving part 12 (for example, position of point A illustrated in FIG. 18), the amount of light L incident on the light receiving part 12 decreases. Meanwhile, when the light L is refracted by the emission surface 35 at a position where the light refracting portion 33 is close to the light receiving part 12 (for example, position of point D illustrated in FIG. 18), the amount of light L incident on the light receiving part 12 increases. Thus, the amount of light L incident on the light receiving part 12 corresponding to the position of the light refractor 33 can be changed.

Furthermore, the light receiving part 12 is composed of a phototransistor, and outputs a predetermined voltage value corresponding to the amount of input light. Then, when the position of the medium guide 21 is aligned with the minimum sized paper P mounted on the mounting portion 4, the medium guide 21 is as close as possible to the light receiving part 12. Therefore, when the position of the medium guide 21 is aligned with the minimum size paper P, the amount of light L incident on the light receiving part 12 by being refracted by the light refractor 33 is a maximum. That is, the voltage output from the light receiving part 12 is a maximum. By such a configuration, when the position of the medium guide 21 is aligned with the minimum size paper P mounted on the mounting portion 4, the size determining part 14 can determine the size of each paper P mounted on the mounting portion 4 using the voltage output from the light receiving part 12 as a reference.

### (Another Example Relating to Example 3)

In this embodiment, an aspect is illustrated where one light emitter 11 composed of an LED element is used as the light source, but it is not limited to this. That is, as described in the first example described above, an illumination light and the like mounted on the outside of the housing 3 may be used as the light source.

### Another Embodiment

In each of the embodiments described above, an example is given of the printer 1, which is one embodiment for the image forming apparatus, but it is not limited to this. For example, one or more embodiments of the present invention may be applied to an image forming apparatus such as a compound device integrally combined with a scanner or printer function, and the like.

Embodiments for the present invention are described above, but the present invention is not limited to the above embodiments, and can have various variations within the scope of the invention.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

One or more embodiments of the present invention is industrially applicable, for example, as an inkjet printer.

### DESCRIPTION OF REFERENCE NUMERALS

1: Printer
2: Device Body
3: Housing
4: Mounting Portion
4a: Mounting Surface
8, 20: Through Hole
11: Light emitter
12: Light Receiving Part
13: Storage space
13a: Storage Space
14: Size Determining Part
15: Controller
21: Medium guide
22: Reflective Surface
23: Slit
33: Light refractor
34: Incident Surface
35: Emission Surface
L: Light

What is claimed is:

1. An image forming apparatus, comprising:
a housing;
a mounting portion in the housing that is configured to hold a recording medium;
one or more light receivers in the housing;
a light adjuster that adjusts an amount of light incident on the light receivers based on presence or size of the recording medium on the mounting portion; and
a controller that determines a size of the recording medium based on the amount of light that has been adjusted by the light adjuster.

2. The image forming apparatus according to claim 1,
wherein the mounting portion comprises a mounting surface in contact with the recording medium,
wherein the light receivers are arranged in a width direction of the housing, between the housing and the mounting surface, and
wherein the light adjuster comprises a through hole that guides light passing through the recording medium in an inclined direction to each of the light receivers.

3. The image forming apparatus according to claim 2, wherein the through hole is provided at a position on the mounting portion shifted from a center of each of the light receivers.

4. The image forming apparatus according to claim 2, wherein the housing comprises a storage space that stores each of the light receivers, on the opposite side of the mounting surface on the mounting portion.

5. The image forming apparatus according to claim 2, wherein the through hole is formed through the mounting portion from the mounting surface to each of the light receivers.

6. The image forming apparatus according to claim 2, wherein an opening of the through hole tapers toward a transporting direction of the recording medium on the mounting surface.

7. The image forming apparatus according to claim 2, wherein the through hole is foil red at an acute angle with respect to a vertical direction of the mounting surface.

8. The image forming apparatus according to claim 2, wherein each of the light receivers comprises a phototransistor that receives the light from a light source installed outside the housing.

9. The image forming apparatus according to claim 1, further comprising:
one or more light emitters in the housing,
wherein the mounting portion comprises:
a mounting surface in contact with the recording medium; and
one or more through holes formed through the mounting portion at positions each corresponding to a potential size of the recording medium,
wherein the light emitters are disposed, together with the light receivers, at positions of the through holes between the housing and the mounting surface, respectively,
wherein the light adjuster comprises a medium guide that moves along a width direction of the mounting portion and holds a position of the recording medium in contact with an end portion of the recording medium at a position where the medium guide overlaps each of the through holes; and
wherein the medium guide comprises a reflective surface that reflects the light from each of the light emitters when the medium guide overlaps with the each of the light emitters.

10. The image forming apparatus according to claim 8, wherein the housing comprises a storage space that stores each of the light receivers, on the opposite side of the mounting surface.

11. The image forming apparatus according to claim 8, wherein an opening of each of the through holes tapers toward a transporting direction of the recording medium.

12. The image forming apparatus according to claim 8,
wherein each of the light receivers comprises a phototransistor that outputs a voltage to the controller; and
wherein a first voltage output when the medium guide overlaps the through hole corresponding to each of the light receivers is higher than a second voltage output when the recording medium overlaps the through hole corresponding to the each of the light receivers.

13. The image forming apparatus according to claim 8, wherein a slit is provided in each of the through holes.

14. The image forming apparatus according to claim 1, further comprising
a medium guide that moves along the width direction and holds a position of the recording medium in contact with an end portion of the recording medium,
wherein the one light receiver is disposed at one end portion of the mounting portion in the width direction,
wherein the light adjuster comprises a light refractor that moves on a straight line connecting another end portion of the mounting portion to the one light receiver and refracts light output from a light emitter at a predetermined angle with respect to the direction of the straight line, and
wherein the light refractor refracts the light output from the light emitter away from the one light receiver as the light refractor approaches the other end portion.

15. The image forming apparatus according to claim 14,
wherein the light refractor comprises
an incident surface on which the light output from the light emitter is orthogonally incident; and
an emission surface inclined at a predetermined angle with respect to the incident surface, for emitting light incident on the incident surface.

16. The image forming apparatus according to claim 14,
wherein the one light receiver comprises a phototransistor that outputs a voltage to the controller; and
wherein the phototransistor outputs the voltage that increases as the medium guide approaches the one light receiver.
